(19) United States
(12) Patent Application Publication
(10) Pub. No.: US 2010/0227297 A1
(43) Pub. Date: Sep. 9, 2010

(54) Multi-media object identification system with comparative magnification response and self-evolving scoring

(75) Inventors: Robert L. Harvey, JR., Port Orange, FL (US); Keith David Panfilio, Daytona Beach, FL (US); Brad Eric Hollister, Port Orange, FL (US); Teri Sansing, Port Orange, FL (US); Michael Meddaugh, Ponce Inlet, FL (US); Greg Scarcelli, Oviedo, FL (US)

Correspondence Address: STERNE, KESSLER, GOLDSTEIN & FOX P.L.L.C., 1100 NEW YORK AVENUE, N.W., WASHINGTON, DC, 20005, US

(73) Assignee: Raydon Corporation, Daytona Beach, FL (US)

(21) Appl. No.: 11/523,739

(22) Filed: Sep. 20, 2006

Related U.S. Application Data
(60) Provisional application No. 60/718,320, filed on Sep. 20, 2005.

(51) Int. Cl. F41A 33/00; G09B 9/08; G09B 19/16; G09B 19/00; G09B 5/00; G09B 23/28; G09B 23/00

(52) U.S. Cl. 434/11; 434/30; 434/29; 434/219; 434/308; 434/262; 434/295

(57) ABSTRACT

A multi-media/simulation training system, in conjunction with a specifically developed and utilized training process, that improves target recognition skills and enhances gunnery training. The system has implications in other cognitive development activities, as well as—but not limited to—medical, technological, biological, anthropological and other areas of study with objects requiring accurate recognition and designation, as well as personnel identification devices, games, and entertainment systems. The system uses a combination of verbal and visual error correction, including magnification and rotation of both the test image and the incorrect image identified by the trainee, to enhance observation and knowledge of visible differences.

This patent application claims priority to Provisional U.S. Patent Application 60/718,320, filed Sep. 20, 2005, and incorporated herein by reference in its entirety.

### BACKGROUND OF THE INVENTION

1. Field of the Invention

The invention described herein relates to computer-based training or other “scored” activities related to skills development.

2. Related Art

Many disciplines require reliable, repeated identification of entities in realistic environments. Traditionally, the best way to develop this skill is by practicing it. For military applications, an unskilled person charged with the task of identifying entities as friendly or enemy could be a severe liability resulting in dire consequences. As computers have increased in power and enabled virtual environments, the level of skill in identification can be raised by training before a trainee enters the field. In the past this training process consisted of traditional feedback techniques, conveying to the trainee if he was correct or incorrect for example. Although this technique gives the trainee practice in the identification process it is deficient in providing the trainee with tools to quickly score and correct patterns of inaccuracy. What is needed is a system, method, and computer program product that can present the trainee with visual representations of incorrectly identified entities as well as the correct entity for comparison, as well as a scoring structure that evolves over the course of one's training to more accurately track progress.

### SUMMARY OF THE INVENTION

The invention described herein comprises a multi-media/simulation training system, in conjunction with a specifically developed and utilized training process that improves military target recognition skills and enhances gunnery training. The system has implications in other cognitive development activities, including—but not limited to—medical, technological, biological, anthropological and other areas of study requiring accurate recognition and designation of objects, as well as personnel identification devices, games, and entertainment systems. The system uses a combination of verbal and visual error correction, including magnification and rotation of both the test image and the image incorrectly identified by the trainee, to enhance observation and knowledge of visible differences. An embodiment of the invention uses a computer-based method of self-evolving scoring that is designed to reflect the development of a trainee's skills in a way that is more specific and accurate than the indications made by conventional scoring systems such as overall averages, right versus wrong response ratios, and similar methods.

### BRIEF DESCRIPTION OF THE FIGURES

FIG. 1 illustrates a gunnery training system utilizing an embodiment of the invention.

FIG. 2 illustrates an alternative, table-top training system utilizing an embodiment of the invention

FIG. 3 is a flowchart illustrating the processing of the invention while interacting with a trainee, according to an embodiment of the invention.

FIG. 4 is a login screen as shown to a trainee, according to an embodiment of the invention.

FIG. 5 is a scenario selection screen as shown to a trainee or instructor, according to an embodiment of the invention.

FIG. 6 shows a target emerging into view during operation of an embodiment of the invention.

FIG. 7 shows the target magnified during operation of an embodiment of the invention.

FIG. 8 shows the target and a vehicle named by the trainee during operation of an embodiment of the invention.

FIG. 9 is a flowchart illustrating the process of self-evolving scoring while in use, according to an embodiment of the invention.

FIG. 10 is an example of an image on a computer-monitor screen showing scores acquired by a trainee who has completed one test event during the current exercise, but has experienced other test events during a previous exercise.

FIG. 11 is an example of an image on a computer-monitor screen showing scores acquired by a trainee who has completed more than one test event during the current exercise, but has experienced other test events during a previous exercise.

FIG. 12 is an example of an image on a computer-monitor screen showing the scoring results generated when the trainee has accumulated passing scores in all three categories. All three scores are shown in green in this example.

Further embodiments, features, and advantages of the present invention, as well as the operation of the various embodiments of the present invention, are described below with reference to the accompanying drawings.

### DETAILED DESCRIPTION OF THE INVENTION

A preferred embodiment of the present invention is now described with reference to the figures. While specific configurations and arrangements are discussed, it should be understood that this is done for illustrative purposes only. A person skilled in the relevant art will recognize that other configurations and arrangements can be used without departing from the spirit and scope of the invention. It will be apparent to a person skilled in the relevant art that this invention can also be employed in a variety of other systems and applications.

The invention is a combination of hardware, software, and a training process that was developed to address four concerns:
i. The need for users to properly identify both air and ground targets (including, but not limited to, helicopters, fixed-wing aircraft, armored personnel carriers, and tanks) in battlefield scenarios
ii. The need to maximize the ability of users to differentiate between friendly and enemy targets
iii. The need for items i. and ii. above to be scored objectively, in such a way that users are enabled to recognize their target-identification weaknesses and strengths.
iv. The need for those weaknesses, once recognized, to be immediately and effectively remediated.

### Hardware

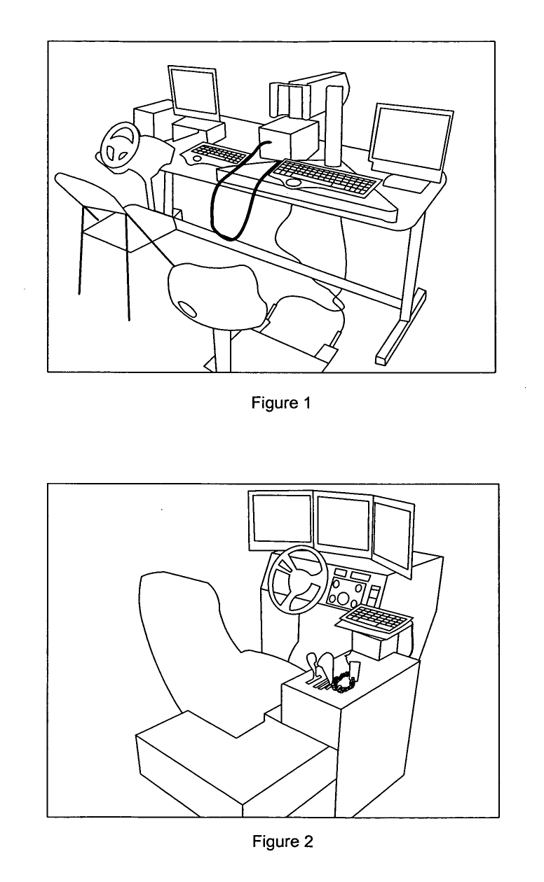

In an embodiment of the invention, the hardware for this system (FIG. 1), includes the following items, which can be connected using cables, or any other medium known to those of skill in the art:
A central processing unit, including sound and graphics processing capability, such as sound and graphics cards
A visual output device, such as a flat-screen or standard computer monitor
A device for inputting alphanumeric information, such as a computer keyboard
Audio input and output devices, such as earphones/headphones with a microphone
A pointing device, such as a control handle or joystick for sighting on the target
Power cords and a 110 volt power connection, or means to connect to an alternative power source.

In the embodiment of the invention illustrated in the accompanying figures, the central processing unit is a personal computer operating a version of the Windows operating system. In alternative embodiments, other computing platforms and/or operating systems may be used.

In an embodiment of the system, these components are set up on a table, desk, or other flat surface. In an embodiment of the invention, one or more carrying cases may be used to allow site-to-site portability.

### Software Operation and the Instruction Process

The software component of the invention comprises a program that results in an interactive, multimedia method of virtual instruction. The software component uses voice-recognition commands and responses. One embodiment of the invention contains 34 target images. Other embodiments may contain more images, or may contain fewer images than 34.

The cognitive teaching process inculcates ordinary redundancy of exposure with verbal and visual cues accumulated into a multi-media delivery system that utilizes a unique method of target-image comparison to enhance the potential for detail differentiation and retention.

Another component of the invention is the virtual instruction process. This combines conventional objects and tasks, including (but not limited to) animated images; random selection of targets; redundancy of images; verbal (oral) redundancy of information;

Variable Settings; Visibility Scaling; Voice Recognition, and Target Sighting into a Process of Exposure, Repetition, and Reinforcement.

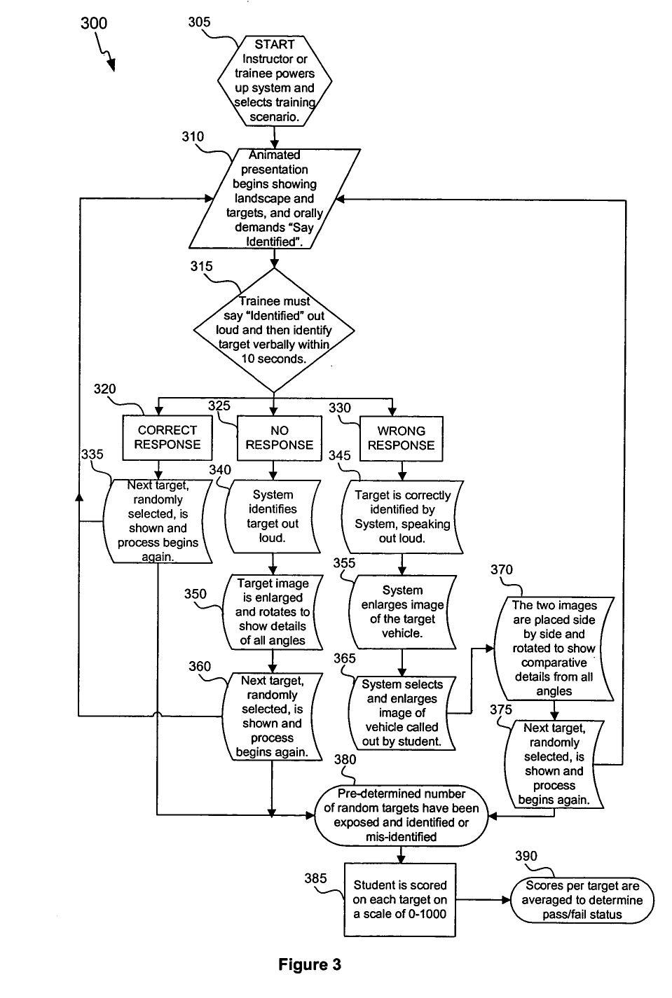

An embodiment of the virtual instruction process is illustrated in FIG. 3. The process starts with powering up the system and selection of a training scenario (305). An animated presentation then begins, showing one or more targets in some setting, such as a landscape or with buildings, to act as cover for the target. In an embodiment of the invention, the system is animated so that target vehicles come out from behind cover and are exposed for identification. The target may be shown in a day sight view or in a night vision (thermal) image, depending on how the system is configured by an instructor. Moreover, the instructor may, in an embodiment of the invention, designate the distance from which the target is viewed. This would therefore affect the level of detail available to the trainee.

The trainee will then be told by the system to identify the target (310). In the illustrated embodiment, the system addresses the trainee through an audio output, and orders the trainee to say, “Identified.” The trainee must then say, “Identified” out loud, then identify the target (e.g., Marder, Merkava, Hind-D) within some fixed interval of time. In the illustrated embodiment, the identification is done orally by the trainee. The interval of time in which the trainee must identify the target is ten seconds in the illustrated embodiment (315). In alternative embodiments, the interval may be a different length, and/or may be adjustable by an instructor.

If the trainee's response is correct, another target is presented, and the process then begins again (320, 335). In the illustrated embodiment, the next target is chosen randomly by the system. Note that in the course of a single session, the trainee may be asked to identify a given target multiple times. Moreover, a random mix of friendly and enemy vehicles may be presented to the trainee.

If the trainee's response is wrong, the correct answer is given by the system (330, 345). Again, this may be done using audio output. The image of the target is then enlarged (355). An image of the target named by the trainee is also displayed, adjacent to the original target (365). In an embodiment of the invention, both targets are then rotated, showing the targets from a plurality of perspectives and allowing the trainee to compare them (370). Another target is then selected by the system at random and displayed to the trainee as the process begins again (375).

If the trainee provides no response, the system will repeatedly instruct the trainee to say, “Identified.” If no response is provided in the allotted time, the system identifies the target (325, 340). Again, this may be provided to the trainee using the system's audio output. The target image is then enlarged and rotated, so that the trainee can see the target from multiple perspectives (350). Another target is then chosen and displayed by the system, and the process begins again (360).

After a predetermined number of targets have been shown to the trainee, the system is scored (380, 385). In the illustrated embodiment, a score is generated for each target, i.e., how many times the trainee correctly named each given target. The scores can then be averaged to generate a grade, e.g., passing or failing (390). Alternative grade generation algorithms are also possible in alternative embodiments of the invention, as will be described below.

### Trainee Operation

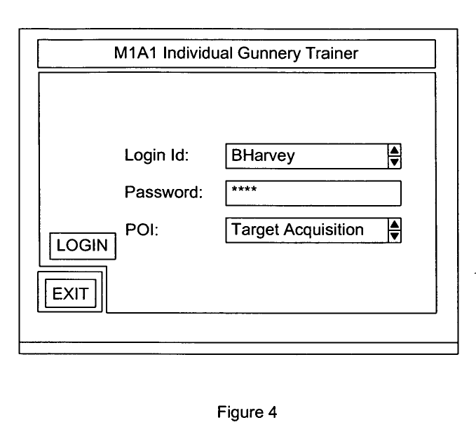

Operation of the invention, according to one embodiment, is illustrated in FIGS. 4-7 and described below.

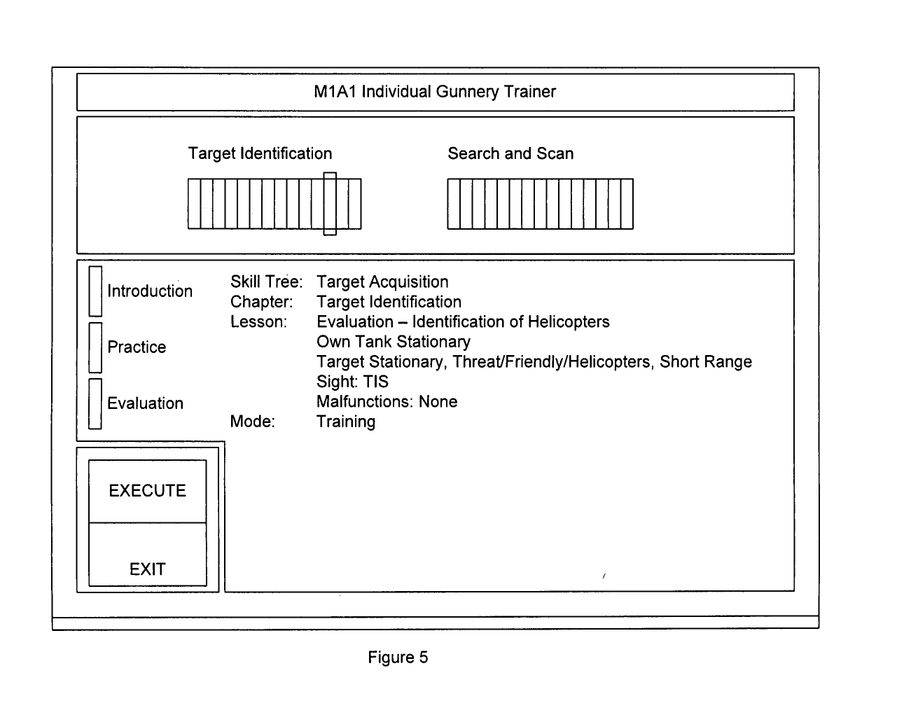

Trainees log into the system using a unique screen name and password (FIG. 4). Scenario selection options are made by the instructor or trainee using an on-screen menu (FIG. 5). Selection options may include, for example:
Only ground vehicles
Only air vehicles
A random mix of ground and air vehicles
Day vision or night (thermal) vision
Distance to vehicles.

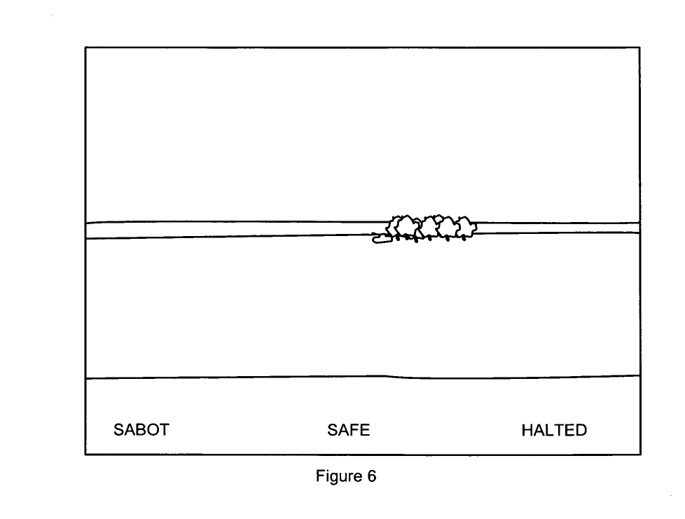

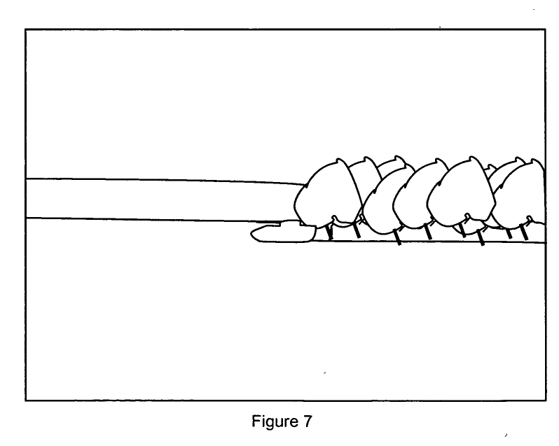

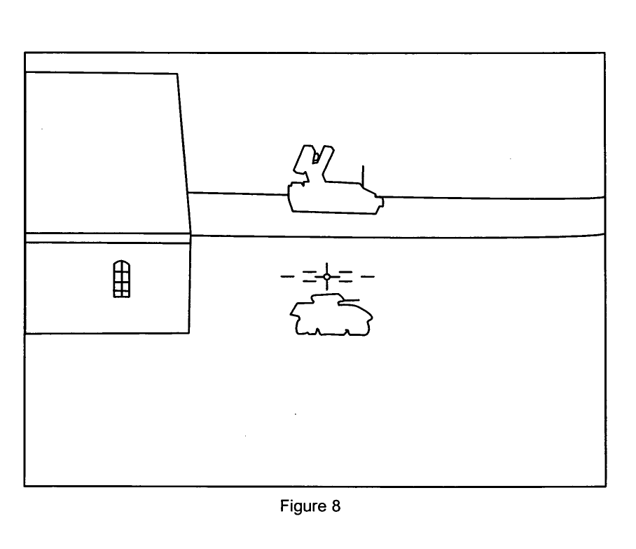

The scenario then begins, displaying a landscape on which no targets are immediately visible. A randomly selected target begins to move into view from behind tree lines, buildings, or other cover (FIG. 6). Trainees use the provided vision system to “zero in” on the target (FIG. 7). The trainee is then prompted to identify the target, as described above.

At the conclusion of a session (e.g., the display of some predetermined number of targets), a score is calculated and presented to the trainee. A pass/fail status can be determined and shown to the trainee. The score and/or the pass/fail status are recorded in the system, along with trainee's name and date of test. Similar data can be maintained for other trainees.

The trainee may repeat the session if necessary. Targets can be randomized each time, so the trainee cannot memorize their order. New scores can be earned and recorded each time the test is attempted.

### Software Scoring Algorithm Process

An embodiment of this invention comprises an algorithm set developed into a program that gathers, retains, and calculates the accuracy of an operator or trainee's responses to a configurable number of randomly provided related questions or other consecutive demands for response, selecting only and continuously the responses that are within the configured quantity of most-recent consecutive responses.

In an embodiment, these calculations result in a group of three scores: one for the individual question or identification, one for the average of the scores achieved during that individual exercise, and a third that incorporates the results of previous training efforts, if and only if, they are within the configured number of most-recent consecutive responses.

In this embodiment, the calculated scores are presented visually on the computer monitor. In other embodiments, the scores may be presented orally via head phones, computer speaker, or other device.

In an embodiment, the scores are presented in contrasting colors. Red type can be used to for any or all of the three scores that are less than a configured passing score. Green type can be used for any or all scores that meet or exceed the configured passing score. In other embodiments, scores may be presented in a single color or in these or other contrasting colors.

In the systems shown in the photographs using an embodiment, situations requiring a series of physical actions from the trainee are presented using a combination of oral and visual cues, including the use of animated computer graphics. Other embodiments may present questions in other appropriate and functional means, with or without animation and/or graphics.

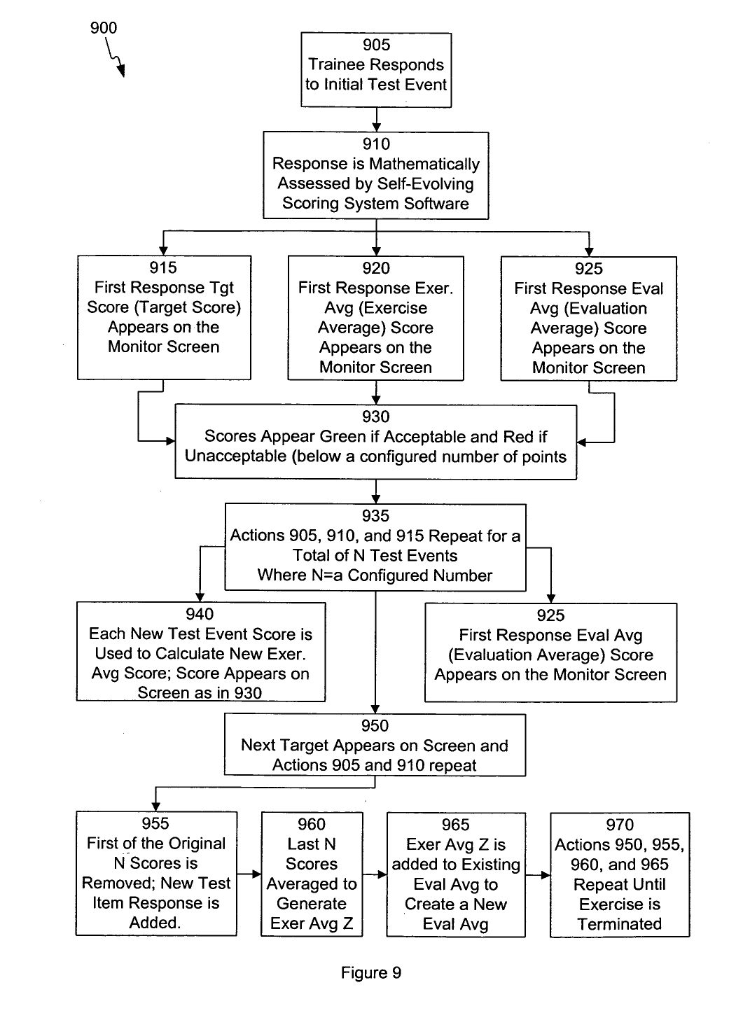

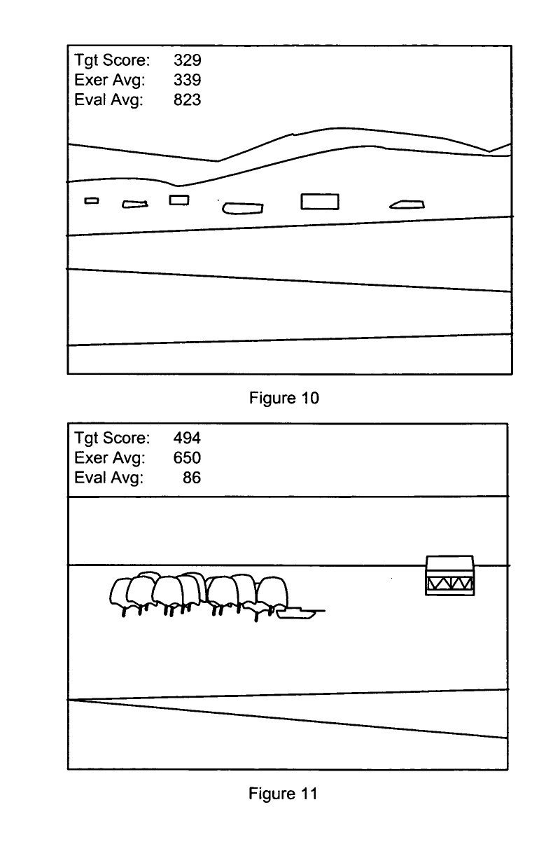

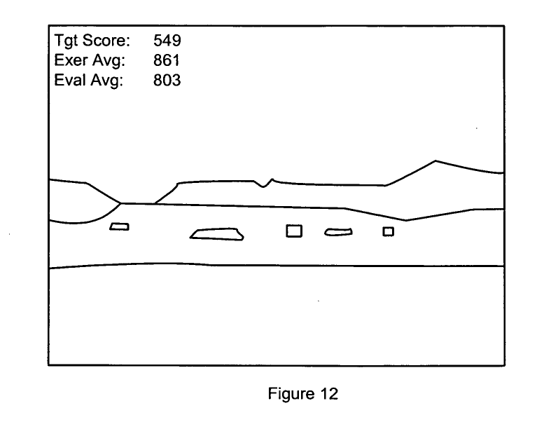

An embodiment is illustrated in FIG. 9. In this embodiment, the process starts with an initial test event to which the trainee responds (905). Test events may include, but are not limited to, orally- or visually-delivered questions, graphic presentation of objects for identification, dialogue boxes offering answer options, multiple-choice questions, situations requiring trainees to manipulate controls, and questions requiring trainees to keystroke (type) a response.

The trainee response is then mathematically analyzed (910) to determine whether the response is correct or not, and to assign a numerical value based on a range of numerical possibilities incorporated into the algorithm set.

As a result of the actions described in paragraph 0042, above, three scores are calculated and presented to the student (915, 920, 925). In an embodiment, the scores appear on the computer-monitor screen. In other embodiments, the scores may be presented in some other method, e.g., orally.

In an embodiment, the first score presented (915) is a numerical response to the single most recent test event.

In an embodiment, the second score presented (920) incorporates the single most recent test event into the total of the previous test events, if any, during that same exercise. If the total number of test events in that same exercise meets, or is less than, the configured allowable test events, the test event scores are totaled and averaged.

In an embodiment, the third score presented (925) incorporates the single most recent test event into the total of the previous test events, if any, during that same exercise plus any earlier exercises used for the same evaluation. If the total number of test events in these combined exercises meets, or is less than, the configured allowable test events, the test event scores are totaled and averaged.

In this embodiment, all three scores are then presented on the computer-monitor screen. Scores that meet or exceed the configured minimum passing score are shown in a first color, such as green. Scores that are less than the configured minimum passing score are shown in a second color, such as red. This color-based distinction is individually applied to each of the three scores (930).

In this embodiment this process (actions 905, 910, and 915) are repeated until the exercise, or the series of exercises comprising the evaluation, is completed. The response to each new test event is incorporated into the calculations, creating a new total and average, with the new average score displayed on the computer-monitor screen (940, 945).

In this embodiment, this repetition continues as long as the number of test events meets or is less than the configured number of most-recent consecutive responses (935). For example, consider the configured number of most-recent consecutive responses as N. In that circumstance, this process continues throughout the first N responses, but at N+1, the algorithm set (950) causes a substantive change to occur.

In this embodiment, reaching test item N+1 causes the algorithm set to delete the first test item in the series comprising N and then add the N+1 results, creating a new total for series N and new averages for the above scores (955, 960, 965). In this manner, the number in series N is always equal to the configured number of most-recent consecutive responses. In this embodiment, this process continues to repeat until the exercise is terminated. (970)

This technology can be used in other contexts apart from military training. For example, medical personnel can be trained to identify different parts of the body or distinguish between malign and benign structures or tissues. A scientist can be trained to recognize cellular or molecular/atomic structures. Using this invention, airport security personnel can be trained to identify weaponry or other contraband passing through x-ray machines. In general, the invention can be used in any context where a person must be trained to recognize a particular class of objects and distinguish such objects from others.

While some embodiments of the present invention have been described above, it should be understood that it has been presented by way of examples only and not meant to limit the invention. It will be understood by those skilled in the art that various changes in form and detail may be made therein without departing from the spirit and scope of the invention as defined in the appended claims. Thus, the breadth and scope of the present invention should not be limited by the above-described exemplary embodiments, but should be defined only in accordance with the following claims and their equivalents.

1. A recognition training system for teaching a user to identify an entity in a virtual environment, the system comprising:
(a) a computer;
(b) a visual output device configured to display output from said computer; and
(c) devices configured for audio input to and audio output from said computer, said computer configured to receive audio input from the user regarding the identity of an image of an entity presented to the user,
(d) wherein said visual output comprises visual feedback for correction of the user's errors, and
(e) wherein said visual feedback comprises visual manipulation of both an image of the correct entity and an image of an incorrectly identified entity.

2. The system of claim 1, wherein said virtual environment resembles substantially realistic atmospheric and temporal conditions.

3. The system of claim 1, wherein a view of said virtual environment comprises simulating the use of visual and auditory aids.

4. The system of claim 3, wherein said aids comprise one or more of:
(a) night vision;
(b) infrared;
(c) x-ray;
(d) telescopes; and
(e) microphones.

5. The system of claim 1, wherein said entity to be identified comprises one or more of:
(a) a medical entity;
(b) a technological entity;
(c) a biological entity; and,
(d) an anthropological entity.

6. The system of claim 1, wherein said entity to be identified comprises one or more of:
(a) vehicle;
(b) aircraft; and
(c) weaponry.

7. A recognition training method for teaching a user to identify a virtual entity in a virtual environment, the method comprising the steps of:
(a) providing, by a computer-based system, a virtual environment to the user;
(b) providing, by the computer-based system, an image of the entity operating within said environment;
(c) accepting, by the computer-based system, input from the user wherein, said input is a verbal or alpha-numeric representation of the user's identification of the entity; and
(d) providing, by the computer-based system, feedback to the user wherein said feedback comprises one of:
(i) affirmative feedback for a correct identification of the entity; and,
(ii) negative feedback for an incorrect identification of the entity, the negative feedback comprising visual manipulation of both an image of the correct entity and an image of an incorrectly identified entity.

8. The method of claim 7, wherein steps (a) through (d) are repeated for a predetermined entity set.

9. The method of claim 7, further comprising:
(e) accumulating and scoring of the results based on a predetermined algorithm producing one or more scores.

10. The method of claim 9, wherein said scoring comprises:
(i) running a baseline evaluation test at the beginning of the training session that calculates results based on a predetermined algorithm or algorithms producing one or more scores;
(ii) determining said scores to be acceptable or unacceptable based on a predetermined level of acceptability; and
(iii) calculating results based on a predetermined algorithm or algorithms producing one or more scores after each identification.

11. The method of claim 7, wherein said entity comprises one or more of:
(a) a medical entity;
(b) a technological entity;
(c) a biological entity; and,
(d) an anthropological entity.

12. The method of claim 7, wherein said entity to be identified comprises one or more of:
(a) vehicle;
(b) aircraft; and
(c) weaponry.

13. A computer program product comprising a usable medium having control logic stored therein for causing a computer to teach a user to identify a virtual entity in a virtual environment, the control logic comprising:
(a) first computer readable program code means for providing a virtual environment to the user;
(b) second computer readable program code means for providing an image of the entity operating within said environment;
(c) third computer readable program code means for accepting input from the user wherein, said input is a verbal or alpha-numeric representation of the user's identification of the entity; and
(d) fourth computer readable program code means for providing feedback to the user wherein said feedback comprises one of:
(i) affirmative feedback for a correct identification of the entity; and, negative feedback for an incorrect identification of the entity, the negative feedback comprising visual manipulation of both an image of the correct entity and an image of an incorrectly identified entity.

14. The computer program product of claim 13, further comprising:
(a) fifth computer readable program code means for accumulating and scoring of the results based on a predetermined algorithm producing one Or more scores.

15. The computer program product of claim 14, wherein said scoring comprises:
(i) running a baseline evaluation test at the beginning of the training session, wherein the test includes calculating results based on a predetermined algorithm or algorithms and producing one or more scores;
(ii) determining said scores to be acceptable or unacceptable based on a predetermined level of acceptability; and
(iii) calculating results based on a predetermined algorithm or algorithms producing one or more scores after each identification.

16. The computer program product of claim 13, wherein said entity comprises one or more of:
(a) a medical entity;
(b) a technological entity;
(c) a biological entity; and,
(d) an anthropological entity.

17. The computer program product of claim 13, wherein said entity to be identified comprises one or more of:
(a) vehicle;
(b) aircraft; and
(c) weaponry.

18. The system of claim 1, wherein the image of the incorrectly identified entity and the image of the correctly identified entity are visually rotated to display the entities from a plurality of perspectives.

19. The system of claim 1, wherein if no input is received from the user regarding the identity of an image within a threshold period of time the identity of the image of the entity is provided by the system to the user.

20. The system of claim 1, wherein said entity to be identified comprises one or more of:
(a) body parts;
(b) cells;
(c) atoms; and
(d) molecules.
